(19) United States
(12) Patent Application Publication
(10) Pub. No.: US 2004/0056156 A1
(43) Pub. Date: Mar. 25, 2004

(54) Pipe hanger and pipe hanger assembly

(76) Inventor: Carmie Edward Dodson, Georgetown, KY (US)

Correspondence Address: Laurence R. Letson, P.O. Box 910567, Lexington, KY, 40591, US

(21) Appl. No.: 10/254,825

(22) Filed: Sep. 25, 2002

(51) Int. Cl. E21F 17/02; F16L 3/00

(52) U.S. Cl. 248/59; 248/68.1

(57) ABSTRACT

A pipe hanger assembly is assembled from a hanger rod, a hanger block, a pipe support, at least an additional pipe support, pintles in the form of either pintle pins or bolts, and pintle retainers such as clips or nuts. The pipe supports are formed to form a throat into which a pipe is passed to engage the pipe support and the pipe support mated with the hanger block or another pipe support having an extension below the pipe support surface. The hanger block and pipe support are connected by a pintle, and lower supported pipe supports are similarly mated with the higher pipe support extension thereby forming a hanging assembly. A hanger member in the form of a “U-shaped” member also can be mated with the extension of a higher pipe support in order to suspend an additional hanger rod, hanger block and connected pipe support providing a spacing between adjacent pipe supports greater than that of two directly interconnected pipe supports.

### FIELD OF THE INVENTION

This invention relates to the field of supporting or hanging pipes within a building and, more specifically, to a hanger structure used in supporting piping within buildings to provide for the orderly placement and routing of pipes, conduits, tubes or other materials within overhead space above work or living areas.

### BACKGROUND OF THE INVENTION

Commercial, industrial, and high-density residential buildings utilize conduits, pipes, and tubing to distribute electrical wiring, telephone wiring and computer network connections as well as gases such as natural gas, oxygen, carbon dioxide, hydrogen, compressed air and liquids including water, oil or other fluids used or consumed in the course of operations within the building. Each pipe, conduit or tube typically is suspended overhead in an orderly and safe manner from a beam, truss or other structural member of the building. During construction, the types of pipes installed may depend upon the intended usage of the space whether it be residential, office space, manufacturing, retail or medical facilities. The varying environments will have differing requirements for wiring, plumbing, and piping for gases, but all typically will use piping in support of activities therein.

Typically, several pipes, conduits or tubes (hereinafter collectively referred to as pipes or piping) are routed along with other pipes in an arrangement wherein a plurality of pipes is suspended above or below other pipes. If pipes are arranged parallel to each other and positioned in a vertical plane, the pipes form a “pipe stack.” As pipes are hung by pipe fitters or plumbers and conduits are hung by electricians, the number of pipes and conduits become more numerous and create a more complex and crowded labyrinth. As the number of pipes supported at any one spot increases, the greater use of specialized pipe supports becomes desirable in order to both minimize space consumed and the height of a pipe stack in order to prevent interference with a dropped ceiling or equipment. If there is such interference, either the piping must be rerouted or the equipment or dropped ceiling repositioned.

As any particular pipe reaches its destination and is routed away from the common route of the other pipes in the pipe stack, the pipe being routed away may not be the bottom pipe. The pipes below the rerouted or branched pipe generally must be maintained at the same distances from the other pipes in the pipe stack, thereby forming a gap. A support is needed that will accommodate the gap and maintain the previous spacing; attempting to otherwise deflect the pipes to overcome the gap may stress the pipes and/or pipe joints, potentially creating leaks. The bending of previously installed conduit to overcome or compensate for such a gap is both difficult and impractical as the necessary length of conduit for a positioning bend is not available.

Much of the work of installing the piping and the pipe hanger support assemblies is accomplished from scaffolds or lifts. Due to elevated work locations, care must be taken to insure safety of a worker by simplifying both the task and the steps to assemble a pipe hanger or pipe hanger assembly as well as to require as few tools as possible.

Further considerations to be accommodated include the fact that the nature of the use of an area of a building may change over time. Any such change may require either refurbishing or removal of some or all of such piping and/or addition or replacement of piping to serve the projected needs in the area.

Changing the pipes within a pipe stack should be anticipated in order to insure that working with any one of the pipes supported at a common point that, even during removal or replacement, will not be impeded by other unaffected pipes.

If removal and/or replacement of a pipe in a particular pipe stack occurs, the remainder of the pipes in that particular pipe stack will remain substantially undisturbed only if a hanger or hanger assembly can be partially disassembled. The remaining pipes may be left suspended on adjacent hangers without damage for a short period of time while the work on the selected pipe is accomplished. Thereafter, the hanger must be reassembled and the partially supported pipes re-supported.

Once a pipe has been removed or replaced, it is necessary that the re-supporting of the pipes must be accomplished such that not only the pipes are positioned in their original position but also any stress on the pipes be reduced to only that which existed on the other pipes prior to a selected pipe's removal and/or replacement.

While piping is desirably routed in pipe stacks of substantial lengths, occasionally the route of one or more pipes within the building may require crossing the route of a pipe stack, and its support can present problems. It is necessary to insure the crossing pipe does not interfere with any of the pipes of the pipe stack yet permits the passage of the crossing pipe at its height while penetrating, if necessary, the plane of the pipe stack.

While the prior art recognized the desireablility of pipe hangers supporting multiple pipes, the prior art hangers do not lend themselves to easy and simple removal of pipes or replacement of pipes with minimal or no disturbance to nearby pipes either in a common stack or supported at a common point.

U.S. Pat. No. 2,560,845 issued Jul. 17, 1951, to J. A. Carpenter, et al. discloses a trapeze bar supported on two brackets to accommodate and support various sized pipes in a horizontal array between the brackets; such a bracket will hinder removal or replacement of one or more of the pipes.

U.S. Pat. No. 3,866,871 issued Feb. 18, 1975 to Robert S. Dupuy, Sr. discloses a series of clamping and locking bars attached to a hanger rod to support and clamp a plurality of pipes in two parallel stacks. The complexity of these supports requires a large number of parts that must be assembled at the support location and does not appear to provide flexibility with the addition of pipes at a later time.

U.S. Pat. No. 4,245,806 issued Jan. 20, 1981, to Charles F. Vangreen discloses a multi-level, multi-pipe hanger. The supports for the pipe to be removed as well as the supports for any pipes below each would have to be individually completely disassembled from the hanger rod as well as individually removed from the pipes that they had previously supported. Such disassembly would be difficult as the pipes below the hanger being removed would block the hanger removal or require their removal and replacement at significant inconvenience and expense.

U.S. Pat. No. 5,921,509 issued Jul. 13, 1999 to T. E. Flood, et al. discloses an assembly of “J-shaped” members and lock bars to form a matrix of cells, each of which can support a pipe extending therethrough. Due partially to the use of a plurality of parallel hanger rods which block lateral installation or removal, the removal and/or replacement of a pipe supported by this matrix assembly requires substantial disassembly of numerous pieces of the matrix complicating the project.

U.S. Pat. No. 6,390,421B1 issued May 21, 2002, to John Scott Rudd discloses a hanger for multiple pipes attachable to a joist. The hanger is in the form of a pipe clamp which closes below the pipe and a pair of support arms extending laterally outward from the clamp closure. The support arms have clips to engage a further pipe.

This Background of the Invention is provided so the subject invention may be more readily understood within the context of the conditions that exist in the field of the invention and is not intended to nor should it be used to limit or restrict either the fields of use of the invention or the scope of the invention as defined by the claims attached hereto.

### OBJECTS OF THE INVENTION

It is an object of the invention to provide an improved pipe support.

It is another object of the invention to provide an improved pipe support assembly.

It is still another object of the invention to improve the ease of installation of pipe supports and piping associated therewith.

It is a further object of the invention to improve the ease of addition of additional pipe supports to existing pipe support assemblies.

It is a still further object of the invention to improve the ease of removal of pipes from existing piping installations using multiple pipe supports in a pipe hanger assembly.

It is an additional object of the invention to improve the ease of re-supporting the pipes which have had their support temporarily removed.

It is a still additional object of the invention to make easier and less costly the remodeling and refurbishing of buildings having suspended pipes.

These Objects of the Invention are provided to focus attention upon the benefits provided by the invention and are not intended to nor should these objects of the invention be used to limit the scope of protection provided by the appended claims.

### SUMMARY OF THE INVENTION

In order to accomplish the above Objects of the Invention, a pipe support or clevis is provided which has an open throat to accept a pipe, conduit or tube extending therethrough. The pipe support is further formed with a depending extension which will accept a bolt or pintle by use of a transverse hole through the extension. The bolt or pintle, in turn, extends through holes in two legs of another similar pipe support clevis disposed with the holes in the clevis legs aligned with the transverse hole. The pipe support clevis may be provided in a plurality of interior forms whereby the interior support surface which engages the pipe and cradles the pipe is formed to accept a selected standard outside diameter pipe. The interior of the pipe support surface engaging the entire bottom semi-cylindrical pipe surface provides both lateral stability to the suspended pipe as well as the desired support.

A conventional support clamp attached to a beam or other structural member supports a hanger block through a threaded support rod which is threaded into the clamp support and the hanger block. The hanger block is provided with a transverse hole which can be aligned with the holes in the clevis legs to accept a pintle or bolt. The bolt or pintle extends through the clevis holes, the transverse hole through the hanger block to support the clevis, and a pipe extending through the clevis.

As summarized above, the clevis provides support for additional depending devises directly or indirectly by suspending a further support rod which, in turn, supports an additional block and an additional clevis as well as an additional pintle or bolt. The further support rod is threadedly engaged with a hanger suspended from the supporting clevis or directly threaded into an axial hole in the bottom of supporting clevis.

The above summarized assembly allows both the easy and reliable addition of pipe and pipe supports below existing suspended pipe supports and also the partial disassembly of a column of pipe supports to allow removal of a pipe, while permitting the addition of a pipe within a gap between existing pipes in the pipe stack.

Due to the invention's structure of the blocks and pipe supports, this assembly eliminates tedious manipulation of the pipe hanger assembly components as the above described holes readily align to allow insertion of a pintle or bolt to assemble the pipe support assembly. As assembly and/or disassembly is simplified, safety is enhanced for the person performing these operations.

The structure of the pipe hanger and pipe hanger assembly improves the flexibility of design of piping routes and placement of pipes without undue consideration being given to the size of the pipes involved.

This Summary of the Invention is provided as a short general description of the invention, and its assembly and use and is not intended to nor should it be used to limit the invention in any manner.

### BRIEF DESCRIPTION OF THE DRAWINGS

FIG. 1 is an illustration of a pipe support member of the invention.

FIG. 2 is an illustration of a pipe hanger assembly showing a plurality of pipe supports and an additional suspension assembly joined with the lowest pipe support to further attach or suspend pipe supports and pipes at a distance below.

FIG. 3 is a an exploded view of the pipe hanger assembly of FIG. 2

FIG. 4 is an illustration of an alternative embodiment of the pipe support member of the invention having a threaded interior surface in its transverse hole to accept short bolts to suspend any depending supporting members of the pipe support assembly in FIG. 2

FIG. 5 is an illustration of a pipe support member of the invention adapted to accept and support a smaller diameter pipe than the pipe support member of FIGS. 1 or 4.

FIG. 6 is an illustration of an alternative embodiment of the pipe support member of the invention which may engage and suspend a hanger support rod without any intervening members.

FIG. 7 is an illustration of an alternative embodiment of a hanger block of the invention which may be advantageously used on the depending end of a hanger support rod depending from a pipe support member of FIG. 6.

FIG. 8 is an illustration of a pipe hanger assembly of the invention with formed rigid sheet material members for engaging hanger support rods if access is available to tighten lock nuts.

FIG. 9 is an illustration of a pintle which may be used in lieu of a bolt and nut to interconnect pipe support assembly members with other pipe support assembly members above or below.

FIG. 10 illustrates a part of a beam, a support clamp, support rod and a hanger support member.

### DETAILED DESCRIPTION OF THE BEST MODE OF THE PREFERRED EMBODIMENTS OF THE INVENTION AS CONTEMPLATED BY THE INVENTOR

In the Description of the Invention as well as for the clear and complete disclosure of the invention and the attached claims, certain terms are selected and used which have meanings ascribed to them as set forth herein; and, to the extent such terms' meanings may differ from their customary meanings, these terms should be afforded the meanings ascribed to them herein.

In this application and claims, the terms “pipe” or “piping” are intended to include conduits and tubing as well as rigid pipe and to be inclusive of such conduits, tubes and tubing and rigid pipe without regard to their material or utilization either to encase other items or to serve as a confining structure for the conveyance of liquid or gasses.

The term “pipe stack” is intended to mean a plurality of pipes arranged and supported in a vertical plane and having a substantial length. Pipes may join or depart from a pipe stack at various points over the length of the pipe stack.

Accordingly, plumbing installations use or incorporate pipe and electrical installations use conduit while industrial fluid distribution systems incorporate pipes and tubes, all of which are herein referred to as “pipes.”

Reference is made to all figures and, at various places in the Detailed Description of the Invention, certain specific figures are highlighted.

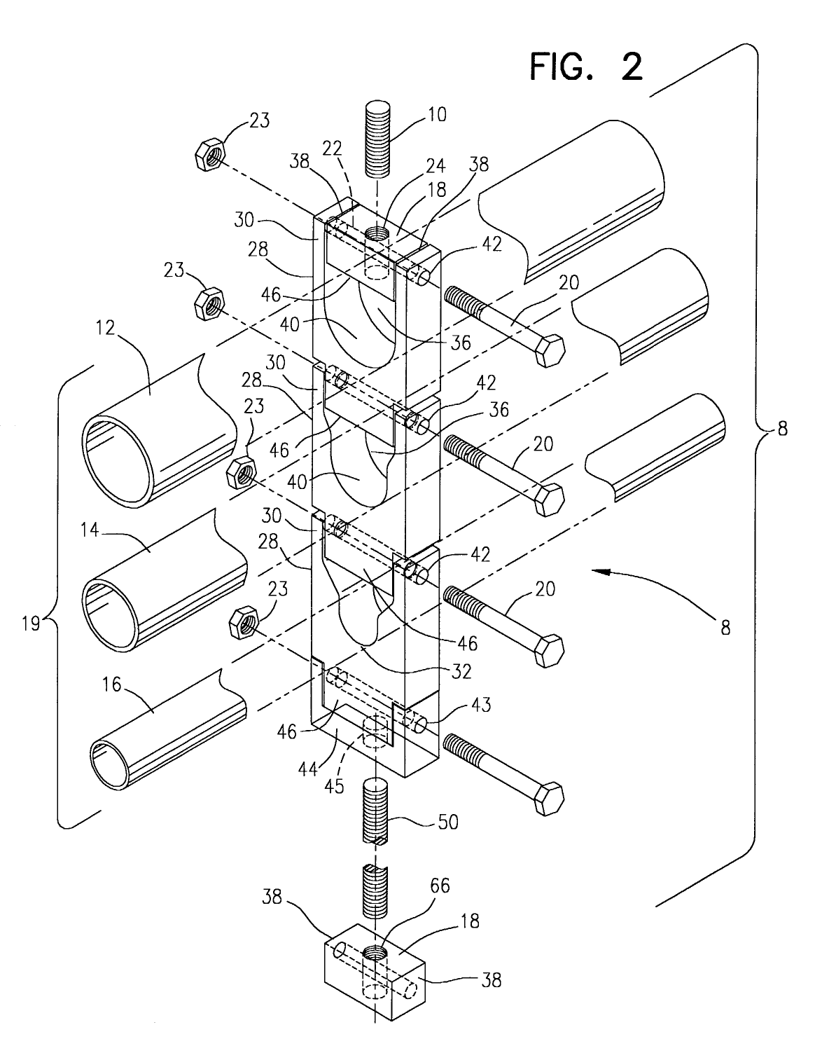

In a building in accordance with national and local plumbing and electrical codes, whenever piping is installed either to convey water, fuels, gases, or compressed air or to support electrical or communications wiring, it is customary and good design practice to route such pipes together wherever possible and support them on common support points. It is advantageous and economical to consolidate the supports so that a plurality of pipes is supported by a common support structure forming a pipe stack. The pipes and pipe stack are preferably supported above the work or living area to leave the floor space unobstructed to pedestrian or vehicular traffic in the work area. Pipes 12, 14, 16 illustrated in FIG. 2 may be selected from various standard diameter pipes available for a multitude of purposes.

In order to suspend the pipes 12, 14, 16 at a desired height, a pipe hanger assembly 8 comprising a threaded hanger rod 10 is secured to a support structural member such as a conventional threaded rod hanger clamp 60, shown in FIG. 10, or its equivalent. The hanger clamp 60 is available either from Cooper Industries, Inc of Houston, Tex. or from numerous electrical and piping supply houses located in most locales. The rod hanger clamp 60 is typically secured to a flange 62 of a beam 64, truss or other overhead structural member (not shown). In order to maximize the work space below and to permit the installation of a dropped ceiling below the piping as appropriate, it is desirable to support piping as close to a ceiling or roof as is possible, taking into consideration any obstacles.

A threaded hanger rod 10 may be of any desired length and allows adjustments in the effective length of the rod 10 to position a pipe stack 19 at a predetermined height or with a predetermined slope if necessary, as illustrated in FIG. 2.

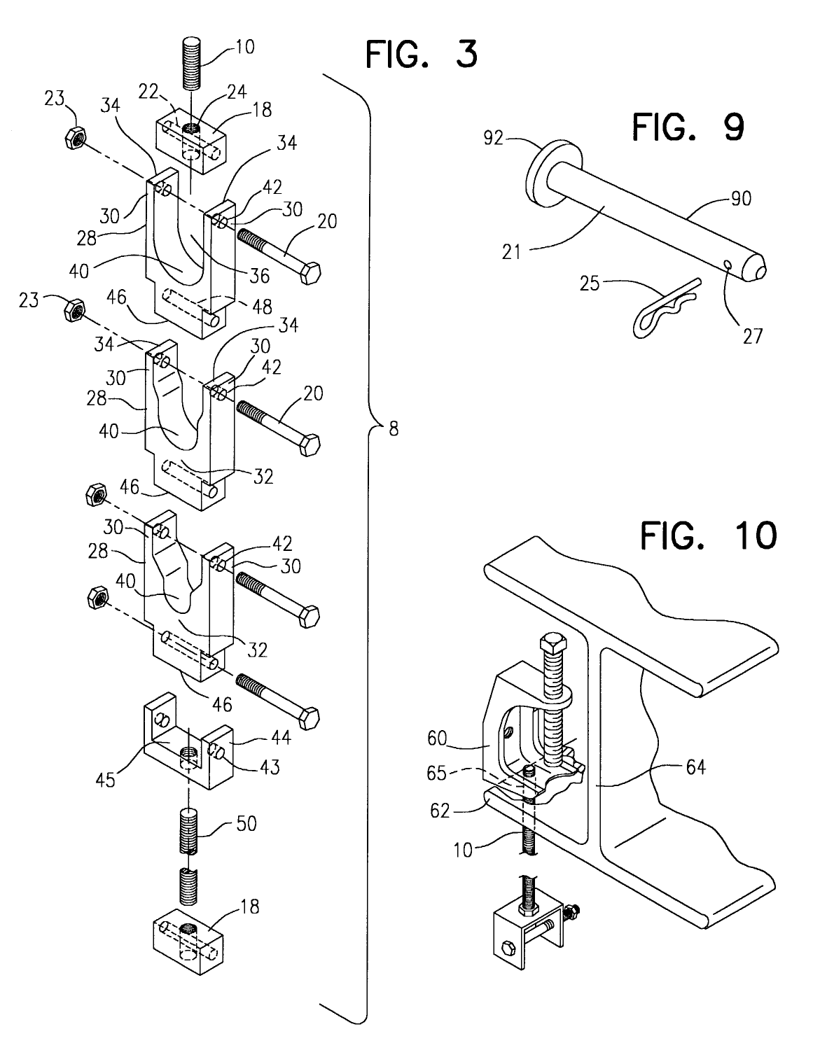

A hanger block 18 of FIGS. 2 and 3 is a block of metal or other rigid material exhibiting high-tensile strength. The hanger block 18 is provided with a transverse hole 22 extending through the block 18 and having a diameter sufficient to accept a bolt 20 inserted therethrough to serve as a pintle. The hanger block 18 is further provided with a second hole 24 disposed with its axis intersecting and orthogonal to an axis of the transverse hole 22. Second hole 24 is preferably internally threaded to accept and support threaded hanger rod 10. The threaded hanger rod 10 is threaded into second hole 24 and may carry an optional lock nut (not shown) thereon to prevent unintended rotation of hanger rod 10 relative to hanger block 18. Lock nuts may not be necessary in many instances as the pipes 12, 14, 16 supported by the pipe hanger assembly 8 prevent rotation. If a lock nut is used, only one such nut can immobilize the threaded hanger rod 10 relative to the hanger block 18 or the rod hanger clamp 60.

Rod hanger clamp 60 shown in FIG. 10 attaches to a beam 64 by clamping onto a flange 62. Rod hanger clamp 60 comprises a threaded hole 65 to accept and support threaded hanger rod 10.

It should be understood that bolt 20 may be replaced with a pintle 21, such as illustrated in FIG. 9. Similarly, it may be desirable to replace bolt 20 with two short bolts 26; the transverse holes 22 or 48 in hanger block 18 and pipe support 28, respectively, may be internally threaded from each end to accept the shorter bolts 26, if desired, as illustrated in FIGS. 7 and 4, respectively. An advantage of using two short bolts 26 to thread into transverse hole 22 of the hanger block 18 permits the hanger block 18 to be threaded far enough onto the hanger rod 10 hole 24 to extend completely through the hanger block 18 and provide a wider range of positions for a pipe 12 relative to the selected length of hanger rod 10.

Pipe support 28 and pipe 12 are supported by the hanger block 18 and bolt 20 or pintle 21, shown in FIG. 2, or short bolts 26 as in FIG. 7. Pipe support 28 in the form of a clevis 28, illustrated in FIGS. 4, 5 and 6, is adapted to support pipe 12. The clevis 28 is formed with two leg portions 30 which extend generally parallel to each other and are joined by a bridging span 32 between legs 30. This formation creates a “U-shape” which cradles and supports the pipe 12, 14, 16. The distal ends 34 of leg portions 30 or legs 30 are spaced apart by a distance which permits passage of a pipe 12, 14, 16 through the throat 36 of the clevis 28. The separation distance between legs 30 must also exceed the length of a hanger block 18 in FIGS. 2, 3 or 7.

With the legs 30 positioned juxtaposed with hanger block 18 in FIGS. 2 or 3, the transverse hole 22 of hanger block 18 may be readily aligned with transverse holes 42 formed near the distal ends 34 of legs 30. Once aligned, bolt 20 or pintle 21 is inserted to suspend the clevis 28 from hanger block 18. If a bolt 20 is used, a nut 23 is threaded onto the bolt 20 and tightened to retain bolt 20 in position. As in FIG. 9, should a pintle 21 be used, a clip 25 may be inserted into a transverse pintle hole 27 proximate the distal end of pintle 21 to retain pintle 21 in its position.

FIG. 9 illustrates a pintle 21 or pin 21 useable to substitute for bolt 20. Pintle 21 has a shaft 90 and an enlarged head 92. The shaft 90 is provided with a transverse hole 27 to accept clip 25 as described above.

A great amount of structural strength is not required of the clip 25 as there is very little loading thereon. Virtually all loading on the pintle 21 is a shear stress, and as such the clip 25 is not loaded to any significant degree.

Disposition of pipe 12 within the throat 36 of clevis 28 is advantageously effected by disposing the clevis 28 partially surrounding a pipe 12 and then aligning the clevis 28 with the throat 36, spanning the length between end faces 38 of hanger block 18.

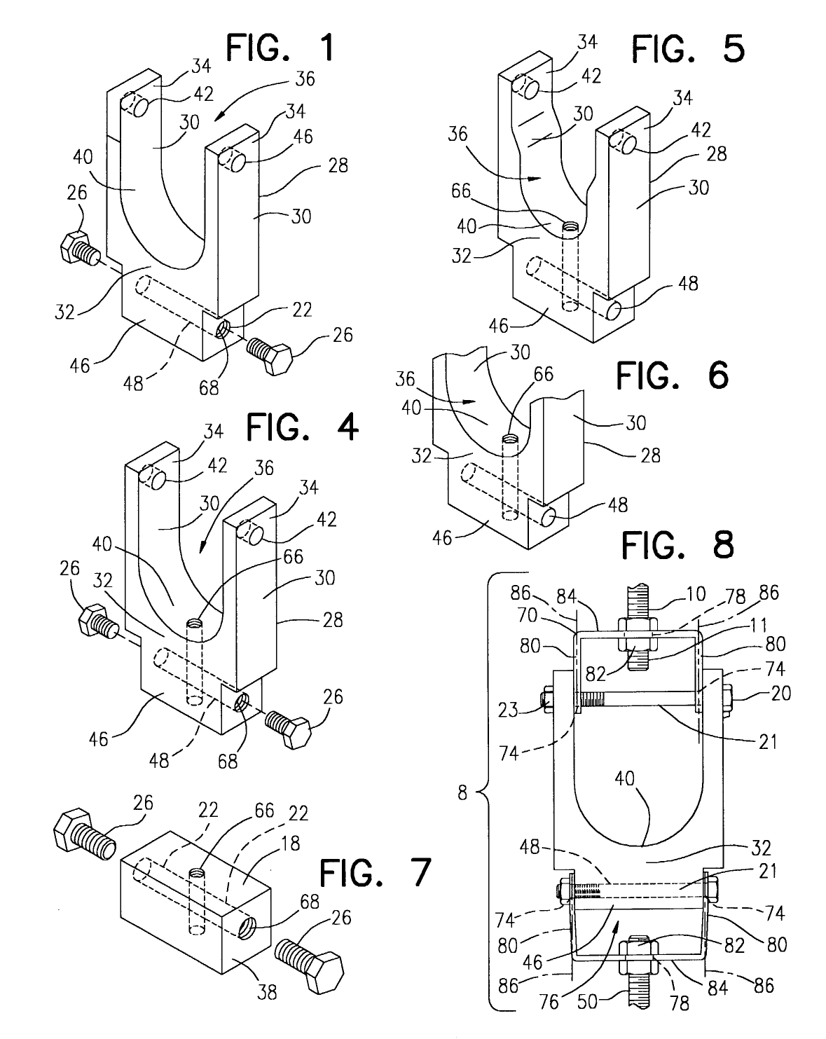

The pipe support surface 40 of clevis 28, illustrated variously in FIGS. 1-6 and 8, is preferably a semi-cylindrical concave surface 40 which engages the exterior of the supported pipe 12, 14 or 16. The diametric dimension of support surface 40 is preferably just enough larger than the outside diameter of the pipe 12, 14 or 16 being supported to insure the seating of the pipe 12, 14 or 16 within and on the support surface 40. The proper dimensioning of the support surface 40 radius also insures that the pipe 12, 14 or 16 will be laterally stabilized, at least relative to the clevis 28.

An extending portion of the pipe support 28 or clevis 28 projecting outwardly from the bridging span 32 provides a block 46 which is further provided with a transverse hole 48. The transverse hole 48 is the equivalent of transverse hole 22 in hanger block 18. Hole 48 may be internally threaded at 68 if it is desirable to use short bolts 26 in order to allow a threaded support rod 50 to be deeply engaged in threaded hole 66 disposed axially of the pipe support 28 and orthogonally to the transverse hole 48, as best illustrated in FIGS. 5 and 6.

In some instances, especially during renovation or remodeling of the area having piping previously installed, one or more pipes may be removed from a pipe stack 19. In such instances, pipe support 28 or clevis 28 supporting a pipe 12, 14 or 16 is removed from a pipe hanger assembly 8, of FIGS. 2 or 3, to facilitate the removal of pipe 12, 14 or 16. The lower devises 28, now unsupported from above, may be re-supported by attaching a hanger support bracket 44 to the lowest supported pipe support block 46. The hanger support bracket 44 is a U-shaped channel member, as illustrated in FIG. 2.

The support bracket 44 has an axial hole 45 extending through the bottom of the U-shaped channel to accept and support threaded hanger rod 50 and the depending parts.

The gap formed by the removal of one or more pipe supports 28 is advantageously filled and the lower disconnected and unsupported pipe hangers 28 re-supported by threading a hanger rod 50 of appropriate length into a threaded axial hole 45 in the bottom of support bracket 44. An additional hanger block 18 is threaded onto the opposite end of hanger rod 50. The lower unsupported one or more devises 28 then may be reconnected and supported by connecting the uppermost unsupported clevis 28 to the additional hanger block 18 with a bolt 20 or pintle 21 as has been described above in the description of the assembly of these parts.

Hole 48 in block 46 of clevis 28 is readily alignable with holes 42 in clevis legs 30 or with holes 43 in support bracket 44 to support depending hanger rod 50, hanger block 18 and devises 28 whenever a bolt 20, bolts 26 or a pintle 21 is inserted into holes 42 or 43 and 22 or 48.

Similarly, additional pipes (not shown) may be supported and routed in existing gaps of a pipe stack 19 by reversing the above process.

FIG. 5 illustrates pipe support 28 or clevis 28 disassembled from any pipe hanging assembly 8. The narrowing of the pipe support surface 40 diameter may be desirable to laterally stabilize a pipe 12, 14, 16 supported therein. However, if the diameter of the pipe support surface 40 of clevis 28 is larger than required, the support function of clevis 28 is generally unaffected, only foregoing the tight lateral constraint of a pipe 12, 14, 16 therein.

An alterative embodiment of the pipe support clevis 28 is illustrated in FIG. 6 wherein an axial threaded hole 66 is provided extending through block 46 or extended portion 46. The hole 66 provides an alternative approach to attaching the threaded rod 50 between one pipe support clevis 28 and a supported depending hanger block 18. While an approach using hanger member 44 was earlier described, this use of threaded hole 66 in pipe support clevis 28 may provide a less expensive alternative if linear thermal expansion and contraction of the supported pipe is not a factor and does not create undue stress on the clevis supporting rod 50.

A further alternative embodiment of the clevis 28 is shown in FIG. 4 wherein the transverse hole 48 is provided with internal threads 68 from each end to accept short standard bolts 26. This provides an ability to intersect the axial hole 66 and the transverse hole 48; this provides some additional adjustability of the relative axial position of rod 50 and pipe support clevis 28 or provides a greater engagement of rod 50 with clevis 28 and, specifically, axial hole 66 to ensure adequate load carrying capacity of the rod 50.

Another alternative to a hanger block 18 is a hanger bracket 70, as illustrated in FIG. 8, which provides a further simplification of the pipe hanger assembly 8 of FIG. 1 by reducing the number of separate unique elements of the pipe hanger assembly 8. The hanger bracket 70 is fashioned with legs 80 of such length as to permit a lock nut 82 to be positioned intermediate extended portion 46 or block 46 of clevis 28 and the bridge 84 of bracket 70. The same bracket 70 would provide room for a lock nut 82 and some hanger rod over-length 11 extending into the throat 36 of pipe support 28. The lock nut 82 is threaded onto hanger rod 10 or 50 extending through rod hole 78 in bridge 84. The legs 80 are positioned extending from the bridge 84 to form a throat 76 of hanger bracket 70 such that the center lines 86 of the thickness of legs 80 are spaced apart by a distance substantially equal to the average of the dimension of throat 36 and the length dimension of transverse hole 48. Thereby, the legs 80 of hanger bracket 70 may be relatively easily spread to fit over block 46 or deflected inward slightly, and thus are insertable within the throat 36 of clevis 28 wherein the dimensions of a clevis throat 36 and the length dimension of transverse hole 48 are very nearly the same.

The deflectability of the legs 80 allows the hanger bracket 70 to become a multi-use bracket. With a substantial gap designed into the interface between the legs 30 of clevis 28 and the length of transverse hole 48 extending through block 46, deflection may not be necessary. The legs 80 of hanger bracket 70 have holes 74 therethrough to align with hole 48 and receive bolt 20 or pintle 21.

One primary advantage of this last embodiment is simplicity and the resultant reduction in the number of unique parts that must be stocked or carried to the work location and up onto a scaffold for installing a pipe hanger assembly.

A second significant advantage of this embodiment is the ease of assembly or disassembly of the hanger bracket to enhance the safety of a worker working at an elevated work location.

This Detailed Description of the Invention is provided to enable one of ordinary skill in the art to practice the invention described and claimed herein. This description of the best mode of the preferred embodiment of the invention should not be and is not intended to be used to limit the invention and the scope of protection afforded by the claims hereof in any manner.

Various embodiments of elements of the invention have been described and illustrated herein. It is the inventor's intention that the description and illustration convey an ability to one of ordinary skill in the art to practice the invention. A person of skill in the art may make minor changes or alterations in the invention, but changes or alterations should be considered to within the scope of protection afforded the invention by the attached claims.

What is claimed is:

1. A pipe hanger assembly for supporting pipes from an overhead structure comprising:
a first threaded rod member;
a hanger member, said hanger member having a first hole to accept said first threaded member and at least a second hole orthogonal to said first hole, said at least second hole extending therethrough;
a first pipe support member formed as a clevis, having a pair of legs, said first pipe support member formed with an interior surface adapted to receive a pipe;
said first pipe support member further comprising a member extending from said exterior of said first pipe support member, said extending member having a hole transverse to said extending member and extending therethrough;
said pipe support member defining a hole extending transversely through each of said legs of said clevis and parallel to said hole transverse to said extending member, each of said holes through said legs aligned to accept a pintle inserted therein, and
said pintle inserted into said holes of said pipe support member and said hole transverse said hanger member,
whereby said first pipe support member is suspended from said hanger member by said pintle and said hanger member is supported by threaded engagement with said first threaded rod.

2. The pipe hanger assembly of claim 1 further comprising a second pipe support member disposed with said legs thereof and said holes transverse said legs thereof aligned with said hole transverse to said extending member and a further said pintle extending therethrough.

3. The pipe hanger assembly of claim 1 further comprising a second hanger member comprising a “U-shaped” member comprising a base portion and a pair of legs, each of said legs forming a hole through each said leg and said holes aligned with each other and aligned with said transverse hole through said extending member of said first pipe support member and a further pintle extending through said aligned holes, said “U-shaped” member further comprising a threaded hole formed in said base portion and a threaded rod engaged in said threaded hole.

4. The pipe hanger assembly of claim 3 wherein said threaded rod additionally supports a further hanger member, a further pipe support member and a further pintle.

5. The pipe hanger assembly of claim 1 wherein said pintle comprises a shaft, an enlarged head on a proximal end, and a hole transverse to shaft proximate a distal end of said shaft, and a retainer engaged in said hole transverse to said shaft.

6. The pipe hanger assembly of claim 1 wherein said pintle comprises a bolt and said bolt is threadedly engaged with a threaded retainer member.

7. The pipe hanger assembly of claim 1 wherein said hanger member comprises a block of cast material.

8. The pipe hanger assembly of claim 1 wherein said hanger member comprises formed sheet of material having at least a pair of legs and a bridging portion intermediate said legs, said legs forming holes therethrough, said legs disposed substantially parallel and separated by a distance to permit each of said holes in said legs to be disposed juxtaposed with one end of said hole extending through each of said legs of said clevis or said extended portion of said pipe support member.

9. The pipe hanger assembly of claim 8 wherein said hanger member legs are disposed exterior to said legs of said clevis.

10. The pipe hanger assembly of claim 8 wherein said hanger member legs are disposed interior to said legs of said clevis.

11. A pipe support for incorporation into a pipe hanger assembly comprising:
a generally “U-shaped” body with a pair of legs disposed in parallel and connected to a spanning portion, said legs and said spanning portion forming an interior passage sized to accept a pipe therethrough;
said legs forming a throat, said throat having a predetermined width;
said spanning portion further comprising an outwardly extending portion of said “U-shape” and having a predetermined width dimension smaller than said throat dimension;
said legs of said “U-shaped” body defining a hole through each of said legs and said extending portion defining at least a hole, said holes in said legs and said hole in said extending portion disposed parallel and transverse to said clevis and alignable with the holes of a similar clevis identical in all respects except the size of said interior passage,
whereby said clevis may be positioned below and connected to said similar clevis by a pintle, thereby depending said clevis below another clevis for supporting a pipe positioned in said interior passage.

12. The pipe support of claim 11 further comprising a hole disposed co-axial with said pipe support and extending at least partially through said extended portion of said pipe support.

13. The pipe support of claim 12 wherein said co-axial hole is internally threaded.

14. A suspension member for suspending a threaded member from a pipe hanger assembly comprising:
a channel member having a “U-shaped” cross-section, said “U-shaped” cross-section formed by a pair of legs disposed projecting from an intermediate bridging portion;
each of said legs having a hole extending therethrough, said holes axially aligned to each other;
a hole formed in said bridging portion and disposed orthogonally to said axially aligned holes,
whereby said suspension member may be attached to a pipe support having a portion extending therefrom and a transverse hole extending through said portion, and a pintle may be inserted into said holes in said legs and an aligned hole in an extended portion of a pipe support, and a further rod may be engaged with said bridging portion and retained therein to support a depending device.

15. The suspension member of claim 14 wherein said suspension member comprises a sheet of material formed to create said “U-shaped” cross-section and having a dimension between said aligned axis of said holes in said legs and said bridging portion and such that space intermediate an extended portion of a pipe support from which said suspension member may be suspended and said bridging portion is sufficient to provide for a nut threadedly engaged with said rod disposed intermediate said bridging portion and said extended portion of said pipe support.

16. The suspension member of claim 15 wherein said suspension member is formed with said legs having a capability of manual deflection permitting deformation of said pair of legs toward each other to permit insertion of said pair of legs within a throat of a pipe support and a deformation of said pair of legs away from each other to permit insertion of an extended portion of a pipe support therebetween.
